(19) United States
(12) Patent Application Publication
(10) Pub. No.: US 2016/0074879 A1
(43) Pub. Date: Mar. 17, 2016

(54) Spiral centrifuge discharge filter discharger

(71) Applicant: Cangzhou Huayou Feida solids control equipment Co. Ltd., Cangzhou City, Hebei Province (CN)

(72) Inventor: Qingxin Min, Tianjin City (CN)

(21) Appl. No.: 14/119,800

(22) PCT Filed: May 20, 2013
(86) PCT No.: PCT/CN2013/075917

§ 371 Date: Nov. 22, 2013

(30) Foreign Application Priority Data
May 31, 2012 (CN) 2012101750788

(51) Int. Cl. B04B 1/08

(52) U.S. Cl. CPC B04B 1/08

(57) ABSTRACT

An auger stripper of a scroll discharge screen centrifuge, which belongs to the technical field of solid-liquid separation equipment, is used for solving the problems that the auger stripper of the existing scroll discharge screen centrifuge is not reasonable in structural design and has a bad solid-liquid separation effect. An adopted auger stripper main body has a structure that a plurality of main blades and auxiliary blades are assembled and connected to an outer body of a rotary taper sleeve, baffles are fixedly connected between the main blades and the auxiliary blades, and a plurality of floating blades are assembled on the outer side parts of the auxiliary blades; and a taper lining is nested in the taper sleeve of the auger stripper main body, after the taper sleeve and the taper lining top of the auger stripper main body are additionally provided with sealing gaskets, an auger stripper top cap is assembled and connected and is connected and fixed by bolts. The auger stripper of the scroll discharge screen centrifuge has a simple and practicable structure. It is suitable for being assembled with various types of scroll discharge screen centrifuges, and is used in chemical, coal, food, oil production and other industries.

### TECHNOLOGY

This invention belongs to the technical field of solid-liquid separation equipment—a kind of spiral centrifuge discharge filter discharger.

### BACKGROUND

The solid-liquid separation equipment spiral discharge filter centrifuge has been widely used in chemicals, coal, food and other industries, especially the oil drilling industry is growing, the need for oil drilling process produces a lot of waste cuttings deliquoring treatment, so the solid-liquid separation equipment technical requirements are also increasing. Spiral centrifuge discharge filter discharger is the core component of the machine, and it is directly related to the quality and effectiveness of solid-liquid separation. In the known technology, the existing discharge filter centrifuge helical screw discharger is mainly used for screw unloader drum body in the drum body, the spiral projection system flute several, or even several of the loading Fixed spiral scraper composition, when the whole assembly of the outer screw discharger with suit filter. However, limited by its structure, the shape of the main blade fixed to the total inner wall of the conical screen there is a gap, the structural design is unreasonable, in particular for the recovery of oil drilling cuttings waste liquid treatment which solid-liquid separation poor results, because the rate of waste drilling fluid containing a large range, where both types of solid particles easily broken sandstone, but also easily dispersed shale hydration, and even fiber. So many changing material properties used existing spiral discharge filter centrifuge processing are mainly displaying in handling materials containing high liquid material directly run while processing containing fine solid particles or sticky fiber-containing materials, but also easy to make the filter clogging also caused run material, often cuttings separated liquid containing about 20%, those containing liquid discharge cuttings and drilling fluid caused environmental pollution and waste of resources.

### SUMMARY OF THE INVENTION

In order to overcome the deficiencies of existing technology to solve the existing unreasonable structural design and the problem of poor solid-liquid separation of the spiral discharge filter centrifuge screw discharger, this invention is to provide a simple and practical structure, solid-liquid separation, and is also suitable for oil drilling cuttings liquid waste recycling, wide application, easy to use fitted with modern spiral spiral centrifuge discharge filter unloader.

The technology programs that this invention is adopted to solve these problems are:

The coiled spiral centrifuge discharge filter discharger, it features: Spiral unloader body, screw unloader cover, gaskets, taper bushing, and screw unloader body by rotating. The outer body sleeve tops even several main blade and vice blades, vanes and vice leaves the main fixed connection between a baffle and an outer surface of the sub-installation of several leaves floating leaves are composed of the main screw unloader Taper Holder with cone bushing kit, screw unloader drogue and main top cone bushing installed after the installation gasket screw discharger even cover fixed by bolting.

The helical spiral centrifuge discharge filter discharger, the vice leaves open system with an outer surface of the groove and the groove openings are installed several floating blades and blade grooves in the corresponding sub-population Ministry mating connector mounted even have floating leaves floating leaves platen.

The helical spiral centrifuge discharge filter discharger, the floating blade system with the outside edge of the platen raised edge, floating inside edge of the blade is formed with an outer plate with floating leaves scoliosis edge relatively fit connection bosses.

The helical spiral centrifuge discharge filter discharger, said screw unloader cover the top of the system, a 3-6 centrifugal impellers are cloth-like material blades reversed.

The referred main blade and vice blade are installed on the taper sleeve on the same angles, and the lower part of the main blade and vice blade tilted to the left or right angle for 10 to 20°.

The lower part of the main blade and vice blade is installed on the outside of the cone bushing, slanting to right with an angle of 13°.

The number of the main blades is an even number, and two main blades are in a group, setting up a vice blade between the two main blades in each group.

As the invention is designed with the technical proposal, it effectively solves the existing unreasonable structural design and the problem of poor solid-liquid separation of the spiral discharge filter centrifuge screw discharger. Several test trial results also shows that, compared with the prior art it has a simple structure and practical, solid-liquid separation, and is also suitable for oil drilling cuttings liquid waste recycling, wide range of applications, ease of use and other beneficial effects, suitable for all types of fitted spiral discharge filter centrifuge, used in chemical, coal, food, oil and other industries.

### BRIEF DESCRIPTION

With the appended drawings and the embodiments in the below, we will explain this invention for further details.

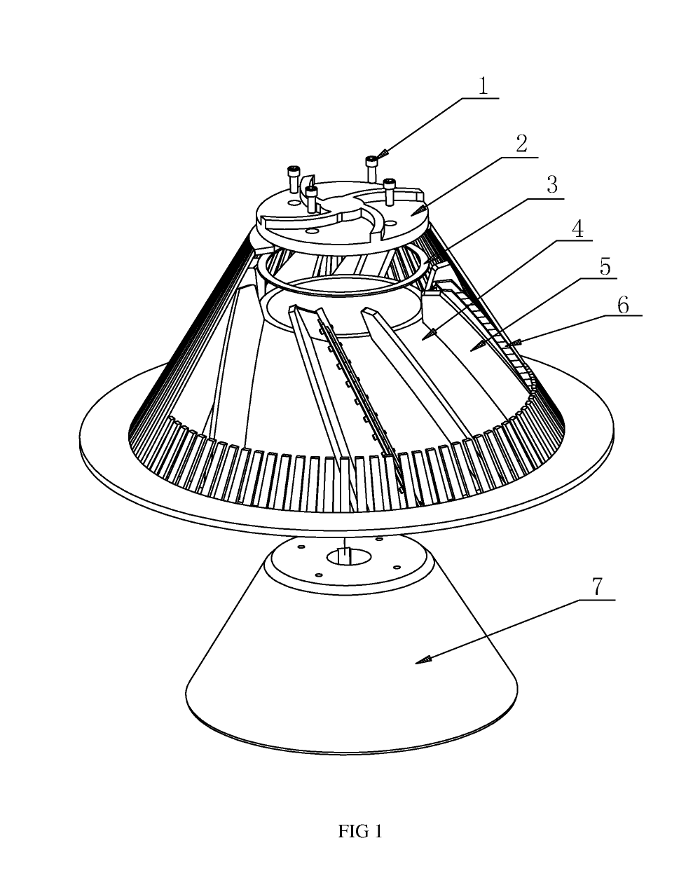

FIG. 1 is a practical embodiment of the invention the structure diagram.

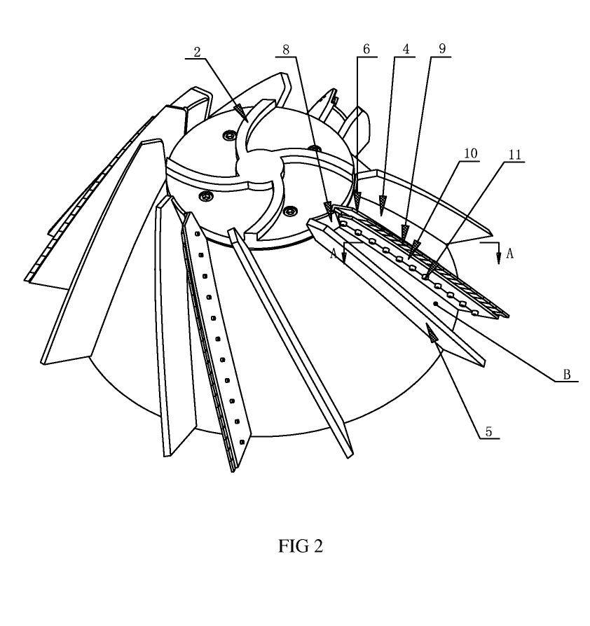

FIG. 2 is the embodiment I screw discharger enlarged body structure diagram.

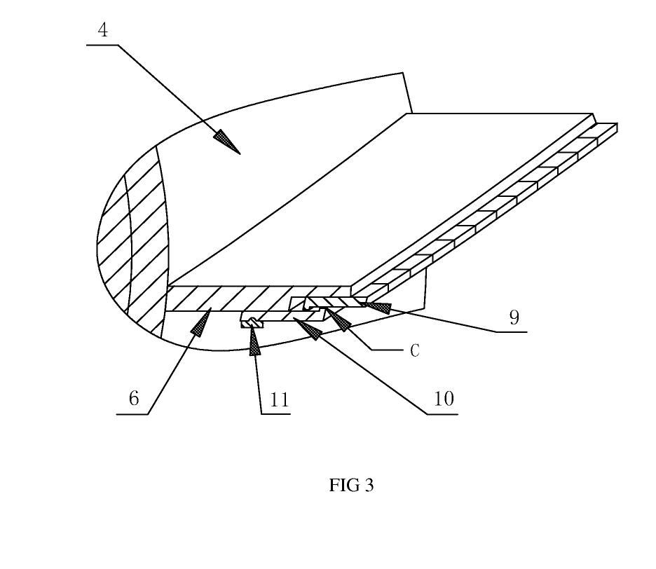

FIG. 2, FIG. 3 is an enlarged sectional view of the AA.

The labeled drawings: a bolt; 2 screw unloader cover; 3 gasket; 4 screw discharger drogue; 5 Wang leaves; 6 leaves; seven-dimensional bush; 8 block plate; 9 floating vane; 10 floating vane plate; 11 screw; C floating plate 6 and the floating leaves a gap between the blade 5.

### Specific Embodiments

As shown in FIG. 1, the invention features: Spiral unloader body, screw unloader cover 2, gaskets 3, cone bushing 7, screw unloader body is tapered Tops outer body case 4 connected with eight primary blade 5 and four sub-blades 6, the primary blade 5 and the sub blade 6 is connected between the fixed plate 8 and the outer surface of the blade 6 in the sub-20 equipped with a floating composed of nine blades, screw unloader body within drogue 4 Case with cone bushing 7, screw unloader body sleeve 4 and the top cone bushing 7 installed after the installation gasket 3 even screw unloader cover 2 by bolts I connect fixed; vice leaves six open system has opened the outer surface of the ro recess groove in the sub-blades are equipped with 20 floating blades 9, and in the corresponding sub-blades 6 grooves ro Ministry mating connector mounted even have floating leaves nine floating plate 10 and a screw blade 11 is connected fixed.

Refer to FIG. 2-FIG. 3 embodiment, the floating of the invention the outer edge of the blade plate 10 is formed with raised edge, the floating vane 9 is formed with the inside edge of the blade plate and the floating edge of the table relative to the outer convex with connection bosses, the floating plate 6 and the floating leaves a gap between the blade 5 C, so that each piece of the floating vane within the setting range can distinct activities.

Refer to the FIG. 1-FIG. 2 embodiment, the present invention screw unloader cover 2 system has four centrifugal impeller are cloth-like material blades reversed.

The main blade 5 and vice blade 6 are installed on the screw discharger drogue 4 on the same angles, and the lower part of the main blade 5 and vice blade 6 slant to the left or right with an angle of 10 to 20°. The lower part of the main blade and vice blade are installed on the outside of the cone bushing, slanting to right with an angle of 13°. The number of the main blades is an even number, and two main blades are in a group, setting up a vice blade between the two main blades in each group.

Using inches, the present invention spiral unloader according to design requirements, the assembly to move the spiral centrifuge discharge filter Cal shaft, conical sieve fitted externally. Its working principle is: Operating spiral centrifuge discharge filter dynamic grades drive shaft screw discharger rotation, the material into the screw unloader on the cover, the first will be on the top cover screw centrifugal unloader leaves round-shaped dial feeders full acceleration, which can effectively avoid the acceleration caused by inadequate material directly along the outer surface of the sleeve material flow problems ran away; through the screw unloader cover centrifugal impeller-shaped dial on the feeder full acceleration, will enter the spiral material unloader left to the conical inner wall screen, because the body is equipped with screw unloader baffle cover material will not enter the main blade and the vice leaves the area between, but only will enter the other areas, where the material in the liquid being thrown out due to centrifugal force separation of solid materials will be part of the main blade scraped material while continuing downward spiral spin extractor, because the main blade and conical sieve there is a gap between the network, there will be a thin layer of the material remaining in the conical inner wall of the screen; but since the sub-blade equipped with a floating blade, and each piece can be individually floating vane activity, even there is a shape error conical sieve, floating blade can automatically adapt to the shape of the inner wall of the tapered screen, always close to the conical inner wall of the movement screen, therefore, the main blade scraping residue in the conical inner wall of a thin layer of mesh solid materials, will be always close to the inner wall of the conical sieve floating leaves scraped so that the tapered mesh sieve to maintain patency, solid-liquid separation is good.

The invention is not limited to the above optimal embodiments. Anyone can learn the structural changes in the light of the invention. And all the technical schemes which are same or similar with the invention are belonging to the scope of the protection of the invention.

1. A spiral centrifuge discharge filter discharger has an unloader body, a screw unloader cover, and characterized in that it also has a taper bushing (7), gaskets (3), a screw unloader sleeve body (4) of the outer body tops even several main blades (5) and the sub blade (6), the main blade (5) and the sub blade (6) is connected between the fixed baffle (8), and the sub-blades (6) the outer surface of the floating installation of several blades (9) is composed of the main screw unloader sleeve (4) connecting the inner sleeve taper bushing (7), the spiral unloading the main feeder sleeve (4) and the taper bushing (7) at the top of the installation gasket (3) after the installation by connecting screw unloader cover bolts (1) secure the connection.

2. As claimed in claim 1, wherein the discharge filter centrifuge helical screw discharger, characterized in that the main body of the sub-discharge screw blade (6) is formed with an opening on the outer surface of the recess and the recess respectively attached to several floating vane (9), and in the corresponding sub-blade (6) connected to the groove mouth portion with a floating vane (9) has a variable blade mounted even plate (10).

3. According to claim 2, wherein the discharge filter centrifuge helical screw discharger, characterized in that the floating vane plate (10) is formed with the outer edge of the raised edge, the floating vane (9) is formed with the inner edge of the outer plate with floating leaves opposite mating connector scoliosis Edge boss.

4. According to claim 1 wherein the helical spiral centrifuge discharge filter unloader, wherein the screw unloader cover (2) the top of the system, a uniform 3-6 centrifugal pump impeller shape dial material leaves.
